(19) United States
(12) Patent Application Publication
(10) Pub. No.: US 2019/0256074 A1
(43) Pub. Date: Aug. 22, 2019

(54) METHOD FOR MORE FUEL EFFICIENT ROAD VEHICLES

(71) Applicant: ABDALLA ARAF ADEL-GARY, AMMAN (JO)

(72) Inventor: ABDALLA ARAF ADEL-GARY, AMMAN (JO)

(21) Appl. No.: 15/898,436

(22) Filed: Feb. 17, 2018

(51) Int. Cl. B60W 10/06; B60W 10/08; B60W 10/101

(52) U.S. Cl. CPC B60W 10/06; B60K 6/445; B60W 10/101; B60W 10/08

(57) ABSTRACT

Current road vehicles utilize relatively high speed piston engines that satisfy the drivability constraint of a road vehicle and to get a decent amount of power from a relatively small size engine. With the success of the hybrid vehicle and related technologies such as (CVT) continuously variable transmission and the electronic CVT, the drivability constraint on engine design can be removed and the use of more fuel efficient slow speed piston engines can be utilized yielding a more efficient road vehicles than those currently available. Of course, the volumetric displacement of a slower engine must be larger than that of a similar faster engine delivering same power output, but this does not necessitate that the slower engine must be heavier than the faster engine. In addition current road vehicles can accommodate bigger size engines and it is a sacrifice well paid for resulting in a more efficient road vehicle.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Road vehicles today consume the biggest percentage of energy and despite all technological advancement the actual efficiency of these vehicles are much less than the thermal efficiency of the piston engines that powers these road vehicles due to losses. A considerable percentage of these losses are mainly due to friction and breathing losses in these piston engines.

One of the main constraints on the design of these engines are the drivability constraint of a road vehicle and extracting a decent amount of power from a relatively small size engine. These constraints lead to designing engines that operate at a wide range and relatively high mean piston speed.

Despite the existence of more fuel efficient piston engines like those used in marine applications that operate at slower mean piston speeds than those used in current road vehicles. Such slow speed piston engines (engines that operate at slow mean piston speed) are not used in road vehicles application because of the constraints mentioned above. With the success of current technologies like hybrid vehicles, continuously variable transmissions and electronic variable transmission the drivability constraint on engine design can be removed. With this constraint removed, more fuel efficient slow speed piston engine can be utilized to power road vehicles yielding more fuel efficient road vehicles than those currently used.

### BRIEF SUMMARY OF THE INVENTION

Utilizing a piston engine with relatively slow mean piston speed to power a road vehicle instead of those utilized in current road vehicle that operates at a relatively high mean piston speed, will result in a more fuel efficient road vehicles.

Current road vehicles actually efficiency is much less than the calculated thermal efficiency of the internal combustion engine, which is mainly due to friction losses and breathing losses in the internal combustion engines. Current road vehicle engines are designed to deliver power at relatively high mean piston speed whereby satisfying the drivability constraint of a road vehicle and getting decent amount of power from a relatively small size engine, minimizing power losses in these engines have reached its limit.

Applying current technologies to design and manufacture engines that operate at lower mean piston speed to power road vehicles will lead to more fuel efficient road vehicles than those currently used.

### BRIEF DESCRIPTION OF THE SEVERAL VIEWS OF THE DRAWING

Not applicable

### DETAILED DESCRIPTION OF THE INVENTION

A method for improving fuel efficiency of road vehicles by utilizing piston engines that have mean piston speed slower than those used in current comparable road vehicles. Current road vehicle engines operate at a relatively high mean piston speed that produce a good amount of power from a relatively small size engine in addition it operate at a wide range of speed (power output) thereby satisfying drivability requirement of a road vehicle.

With the success of the hybrid road vehicles, continuously variable transmission (CVT), electronic continuously variable transmission (eCVT), electric cars, and related technologies, the drivability constraint on engine design can be removed. For example, a fuel efficient piston engine that operates at a relatively slow mean piston speed that primarily runs an electrical generator, or that runs an electric generator motor so as to be used to start the engines, where this efficient electrical power generation unit (engine and electrical generator) can be used to power an electrical motor that drives wheels of a road vehicle. This is similar to installing an efficient electrical generation unit in an electric road vehicle whereby the need of mechanical power transmission is not necessary. In addition with this setup the battery size can be significantly reduced without effecting the range. Furthermore, with this setup the disadvantages of an electric car; big size battery, range, and requirement of recharging are eliminated. On the other hand the advantages of this setup such as simplicity where the engine design can be further simplified and optimized to run at a substantially constant speed.

Another example, a fuel efficient piston engine that operates at a relatively slow mean piston speed that delivers power to the wheels of a road vehicle through a CVT or eCVT. Furthermore, any combination of mentioned examples can be used to utilize more fuel efficient piston engines that operates at relatively slow piston speed compared to those utilized in current road vehicles.

Of course there is a draw back for piston engines that operate at low mean piston speed were it must have more volumetric displacement than those operating at higher mean piston speed delivering same power. Consequently the volumetric displacement of the slow piston engine will be more than that of a similar design faster piston engine (engine that operates at faster mean piston speed). The volume of such a slow engine will be constraint by the volume it will occupy in a road vehicle. Current road vehicle can still accommodate bigger size engines and it is an acceptable compromise that will lead to more fuel efficient road vehicles. Furthermore, increasing the volumetric displacement of an engine operating at slow mean piston speed does not necessarily means a bigger size engine, where engine design can be simplified and some engine components can be eliminated.

Other possibilities to overcome the constraint of the volume (size) of the engine that operates at slow mean piston speed is to design a simple two stroke air-cooled engine with a dedicated lubricating system. Whereby, the disadvantage of two stroke piston engine like improper breathing can be easily solved at slow piston speed and the engine life will be longer since life is proportional to piston speed.

Bigger volumetric displacement engines that operate at slower mean piston speed are not necessarily heavier than those with less volumetric displacement engines that operate at a faster mean piston speed delivering the same power. This is due to the fact that power to volume ratio is less for the bigger engine, and by using current technologies in material, manufacturing and the use of a simple design the weight of the bigger engine can be comparable to that of a smaller engine delivering the same power.

Current road vehicles actually efficiency is much less than the calculated thermal efficiency of the internal combustion engine, which is due power losses. A considerable percentage of these power losses are due to losses in the internal combustion engine.

Slower speed piston engines are more fuel efficient due to the following facts; piston friction power losses will be less since piston mean speed is less, breathing losses are less since they are directly related to piston speed, and it is much easier to reduce friction losses for an engine operating at slow substantially constant speed than an engine operating at wide range of speed (high speed).

Without going into details, which type of losses will be decreased and which will increase, the overall losses will be reduced as it is evident from comparing the overall efficiency of marine/boat engines that operates at slower mean piston speed to the current road vehicle engines were both are optimized using current technologies.

### DRAWINGS

Not applicable

I claim:

1. A method for improving fuel efficiency of a road vehicle comprising of:
a piston engine that delivers predetermined power at a substantially slower piston mean speed than those of current engines used in a comparable road vehicle.

2. Said piston engine of claim 1 can be of a type selected from the group consisting of four stroke spark ignition, four stroke compression ignition, two stroke spark ignition, and two stroke compression ignition.

3. The slower piston mean speed of said piston engine of claim 1 is less than about half of those of current engines used in said comparable road vehicles.

4. Said piston engine of claim 1 operates at a rotational speed that is substantially constant whereby said piston engine is better optimized for fuel efficiency than those operating at a wide range of rotational speed.

5. A method for improving fuel efficiency of a road vehicle comprising of:
a piston engine that delivers predetermined power at a substantially slower piston mean speed than those of current engines used in a comparable road vehicle;
an element selected from the group consisting of electrical generator and electrical motor generator that is coupled by means for coupling rotational energy to said piston engine;
an element selected from another group consisting of electrical motor and electrical motor generator, that drive at least one of the wheels using power produced by one of the element of said group whereby the drivability constraint on said piston engine is eliminated; and
a battery to store surplus electrical power produced by one of the element of said group and to store electrical power produced by the electrical motor generator of said another group during said road vehicle braking whereby the stored power in said battery can be used as source of energy to run one of the element of said another group based on power demand of said road vehicle.

6. Said piston engine of claim 5 can be of a type selected from the group consisting of four stroke spark ignition, four stroke compression ignition, two stroke spark ignition, and two stroke compression ignition.

7. The slower piston mean speed of said piston engine of claim 5 is less than about half of those of current engines used in said comparable road vehicles

8. Said piston engine of claim 5 operates at a rotational speed that is substantially constant whereby said piston engine is better optimized for fuel efficiency than those operating at a wide range of rotational speed.

9. A method for improving fuel efficiency of a road vehicle comprising of:
a piston engine that delivers predetermined power at a substantially lower piston speed than those of current engines used in a comparable road vehicle; and
an element selected from the group of continuously variable transmission and electronic continuously variable transmission that transmits said piston engine rotational power to at least one of the wheels of the said road vehicle.

10. The slower piston mean speed of said piston engine of claim 9 is less than about half of those of current engines used in said comparable road vehicles.
